(19) United States
(12) Patent Application Publication
(10) Pub. No.: US 2018/0083368 A1
(43) Pub. Date: Mar. 22, 2018

(54) DONOR PANEL ANTENNA

(71) Applicant: Westell, Inc., Aurora, IL (US)

(72) Inventors: Anthony Teillet, Aurora, IL (US); Niranjan Sundararajan, Aurora, IL (US); Yatin Buch, Aurora, IL (US)

(21) Appl. No.: 15/706,466

(22) Filed: Sep. 15, 2017

Related U.S. Application Data
(60) Provisional application No. 62/396,061, filed on Sep. 16, 2016.

(51) Int. Cl. H01Q 21/06; H01Q 1/42; H01Q 21/00; H01Q 15/14; H01Q 1/00

(52) U.S. Cl. CPC H01Q 21/062; H01Q 1/42; H01Q 1/005; H01Q 15/14; H01Q 21/0031

(57) ABSTRACT

A low band panel antenna is described. The panel antenna has a double bend reflector, a N×M array of dipole elements symmetrically disposed within an interior portion of the double bend reflector, a five-sided cover. Further, a top portion of the five-sided cover has a dome that is disposed substantially in the middle of the top portion. Moreover, the band panel can be mounted by using a mounting assembly, which further contains two brackets and a concave brace.

### CROSS REFERENCE TO RELATED APPLICATIONS

This Application claims priority to U.S. Provisional Patent Application 62/396,061, filed on Sep. 16, 2016, the disclosure of which is incorporated herein in its entirety.

### TECHNICAL FIELD

The present invention relates to a directive antenna and, more particularly, to a vertically polarized, physically compact panel antenna for use in wireless data communication.

### BACKGROUND OF THE INVENTION

Conventional panel antennas are available in a number of different configurations and materials. However, existing configurations of the conventional panel antenna tend to have excessive side lobe radiation, which may cause electromagnetic interference, and which is wasteful from an energy efficiency standpoint. For example, in receiving antennas, side lobes may pick up interfering signals and increase the noise level in the receiver. Further, many conventional panel antennas do not possess satisfactory directional gain (i.e., have a poor front to back ratio) and often suffer from strong wind load due to their physical configuration. This makes certain conventional antennas unsuitable for use in high-wind environments, such as areas prone to hurricanes and tornados. Additionally, the materials used in the fabrication of conventional panel antenna tend to result in higher than optimal manufacturing costs. A panel antenna having a high directional gain performance, high efficiency, low cost and good ability to withstand a strong wind load is preferred.

### SUMMARY OF THE INVENTION

The invention relates generally to a vertically polarized and physically compact low band panel antenna that has a high directional gain performance and good ability to withstand a strong wind. Embodiments of the present invention provide a panel antenna assembly including a double bend reflector, an N×M array of dipole elements, a five-sided cover, and at least one rigid and integrated feed line.

Further, in certain embodiments, the double bend reflector comprises a plurality of side walls, which defines therebetween an interior portion of the reflector. The double bend reflector is further formed by bending each of the plurality of side walls in a first direction along a first crease at an edge of the interior portion followed by bending each of the plurality of side walls in an opposite second direction along a second crease offset from the first crease. Further, the N×M array of dipole elements is symmetrically disposed within said interior portion and is in electrical contact with the feed line. Moreover, the five-sided cover contains a substantially square top portion and four cover sides, which are attached to and extended downwardly and outwardly from the top portion. In addition, the top portion comprises a dome.

In certain embodiments, the assembly further comprises a mounting assembly, which includes a first bracket, a second bracket and a concave brace. In other embodiments, the mounting assembly further contains a first pole-mounting bracket, a second pole-mounting bracket, a third pole-mounting bracket, and a fourth pole-mounting bracket.

In certain embodiments of the dipole elements each of the dipole element formed with a single metal sheet comprising a top portion which is electrically connected to a bottom support structure incorporating a j hook electrical antenna element. Further, in certain embodiments, a distance between a top center portion of each of the dipole elements and the closest interior portion of the reflector has a range from 50 mm to 85 mm. In other embodiments, the distance between the top center portion of each of the dipole elements and the closest interior portion of the reflector is about 78 mm. In yet other embodiments, this distance is a minimum of 90 mm, and nominally 100 mm. Additionally, in certain embodiments, each of the dipole elements is disposed at a distance of about 220 mm in parallel to an adjacent dipole element and at a distance of about 240 mm in diagonal to an adjacent dipole element.

Embodiments of the invention have certain advantages. By providing a u-shaped, rigid support structure under the antenna radome, antennas according to certain embodiments can withstand increased wind loads compared to conventional designs. Additionally, by providing a steel, symmetrical support structure under the antenna reflector, which is mechanically coupled to a mounting bracket, and then to a mast, antennas according to embodiments of the invention can be more securely mounted during installation as compared with conventional designs incorporating aluminum mounting hardware. Embodiments of the invention use printed circuit board (“PCB”) connections from the antenna feed line to each individual dipole antenna element. This eliminates the need for cables and cable connectors, which provides reduced PIM and interference, particularly when the antenna is subject to mechanical shock. The use of an array of dipole radiators, arranged at a diagonal with respect the reflector walls, provides for less side lobe gain, a higher F/B ratio, and more forward gain, i.e., better directionality and lower interference. In particular, embodiments of the invention provide a minimal spacing between edge dipole elements and the interior walls of the reflector, which reduces fringing effects and leaking of energy into side lobes. Additional advantages will be evident to the person of ordinary skill in the art in view of the following detailed description.

### BRIEF DESCRIPTION OF THE DRAWINGS

The invention will be more fully understood by referring to the following Detailed Description of Specific Embodiments in conjunction with the Drawings, of which:

FIG. 1A is an isometric view of a panel antenna 100;

FIG. 1B is a front view of the panel antenna 100 of FIG. 1A;

FIG. 1C is a side view of the panel antenna 100 of FIG. 1A;

FIG. 2A is an isometric view of a reflector 200;

FIG. 2B is a side view of a portion of the reflector 200 of FIG. 2A;

FIG. 3 is an isometric view of a five-sided cover 300;

FIG. 4 is an isometric view of an N×M array of dipole elements disposed within the reflector 200;

FIG. 5A illustrates an example of a single dipole element;

FIG. 5B is a side view of the single dipole element;

FIG. 5C is an oblique view illustrating an alternative dipole element.

FIG. 6A is an exploded front view of a panel antenna 100 and a mounting assembly 600;

FIG. 6B is an exploded back view of the panel antenna 100 and the mounting assembly 600;

FIG. 7A is a back isometric view of the panel antenna 100 and the mounting assembly 600;

FIG. 7B is a side view of the panel antenna 100 and the mounting assembly 600;

FIG. 7C is an isometric view of a concave brace 700;

FIG. 7D is a front isometric view of the panel antenna 100 and the mounting assembly 600;

FIG. 8 is a side view of a divider;

FIG. 9 is an isometric view illustrating a support bracket 900;

FIG. 10A illustrates a first azimuth gain pattern of one embodiment of the panel antenna 100;

FIG. 10B illustrates a second azimuth gain pattern of one embodiment of the panel antenna 100;

FIG. 10C illustrates a 3-D azimuth gain pattern of one embodiment of the panel antenna 100; and

FIG. 10D shows an array directivity of one embodiment of the panel antenna 100.

### DETAILED DESCRIPTION OF SPECIFIC EMBODIMENTS

References throughout this specification to “one embodiment,” “an embodiment,” “a related embodiment,” or similar language mean that a particular feature, structure, or characteristic described in connection with the referred to “embodiment” is included in at least one embodiment of the present invention. Thus, appearances of the phrases “in one embodiment,” “in an embodiment,” and similar language throughout this specification may, but do not necessarily, all refer to the same embodiment. It is to be understood that no portion of disclosure, taken on its own and in possible connection with a figure, is intended to provide a complete description of all features of the invention.

In addition, the following disclosure may describe features of the invention with reference to corresponding drawings, in which like numbers represent the same or similar elements wherever possible. In the drawings, the depicted structural elements are generally not to scale, and certain components are enlarged relative to the other components for purposes of emphasis and understanding. It is to be understood that no single drawing is intended to support a complete description of all features of the invention. In other words, a given drawing is generally descriptive of only some, and generally not all, features of the invention. A given drawing and an associated portion of the disclosure containing a description referencing such drawing do not, generally, contain all elements of a particular view or all features that can be presented is this view, for purposes of simplifying the given drawing and discussion, and to direct the discussion to particular elements that are featured in this drawing. A skilled artisan will recognize that the invention may possibly be practiced without one or more of the specific features, elements, components, structures, details, or characteristics, or with the use of other methods, components, materials, and so forth. Therefore, although a particular detail of an embodiment of the invention may not be necessarily shown in each and every drawing describing such embodiment, the presence of this detail in the drawing may be implied unless the context of the description requires otherwise. In other instances, well known structures, details, materials, or operations may be not shown in a given drawing or described in detail to avoid obscuring aspects of an embodiment of the invention that are being discussed.

The invention as recited in claims appended to this disclosure is intended to be assessed in light of the disclosure as a whole.

Embodiments of Applicant's invention are disclosed to describe a vertically polarized low band panel antenna. Antennas according to the invention have a high performance and efficiency, and are particularly well suited for roof-top mounting locations where the antenna may serve as a link between cellular Base Station (BTS) and an in-building repeater or distributed antenna system (DAS) to improve in-building cellular data coverage. At a high level, embodiments of the invention include an array of center tap dipole radiators located within a rectangular reflector, where the radiators are fed with an integrated feed line (i.e., PCB feed line), as opposed to with cables, in certain embodiments, as few as 9 radiators are used, and no radiator is within about 25 mm of a wall of the reflector, and preferably, is greater than 90 mm from a wall of the reflector. As described herein, “about” is used to show a plus or minus difference of 10% in any measurement. The radiators are covered by a polymeric radome, resulting in an overall package that is compact and able to withstand a high wind load.

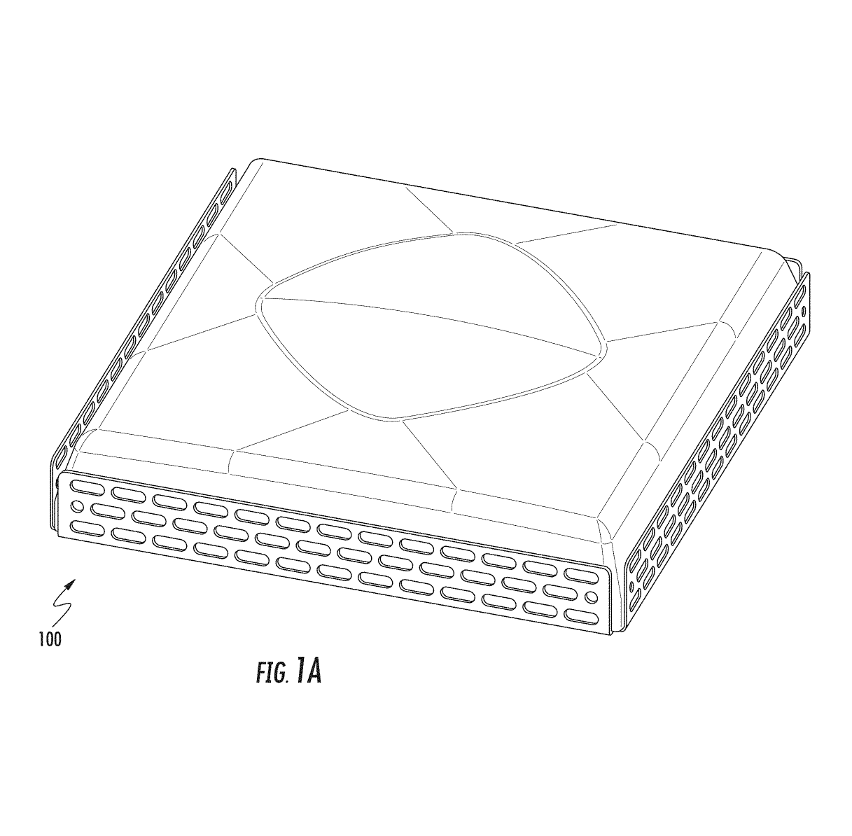

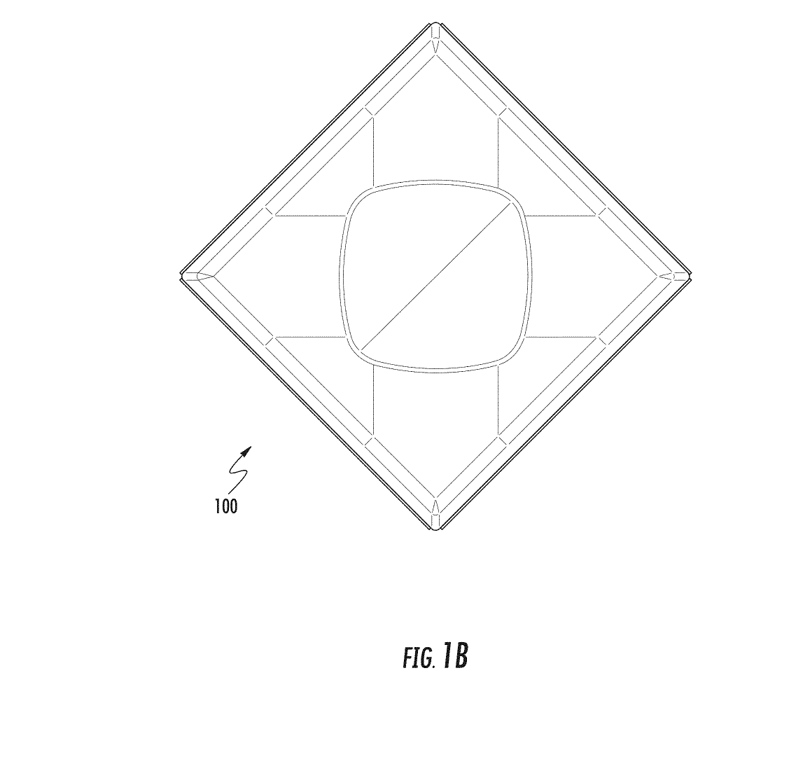

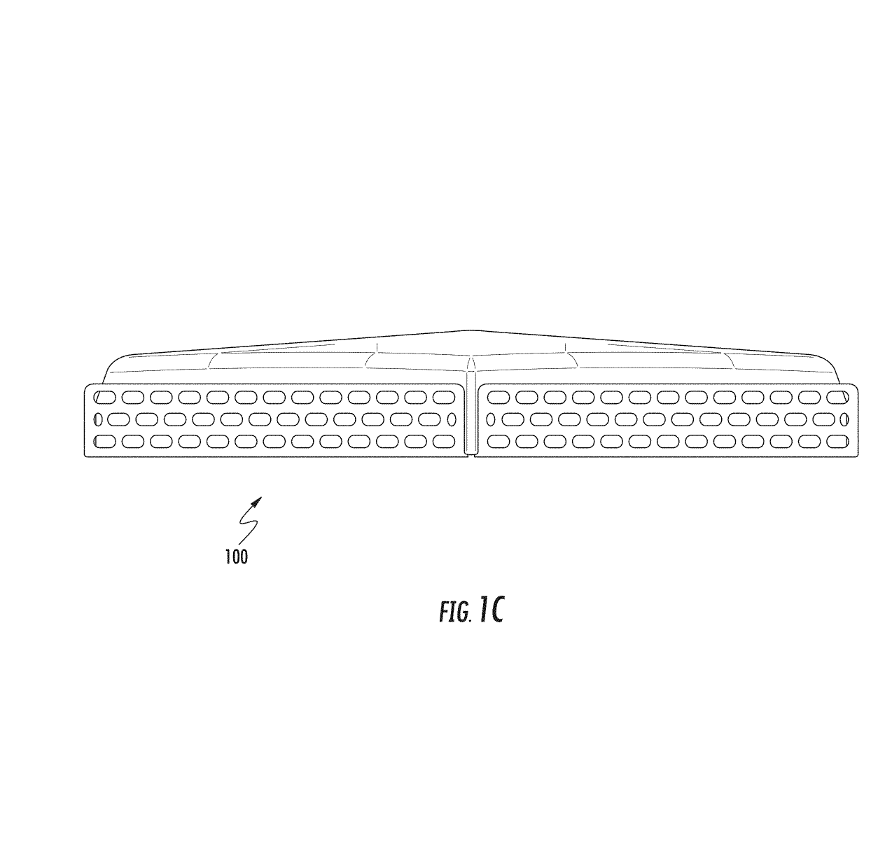

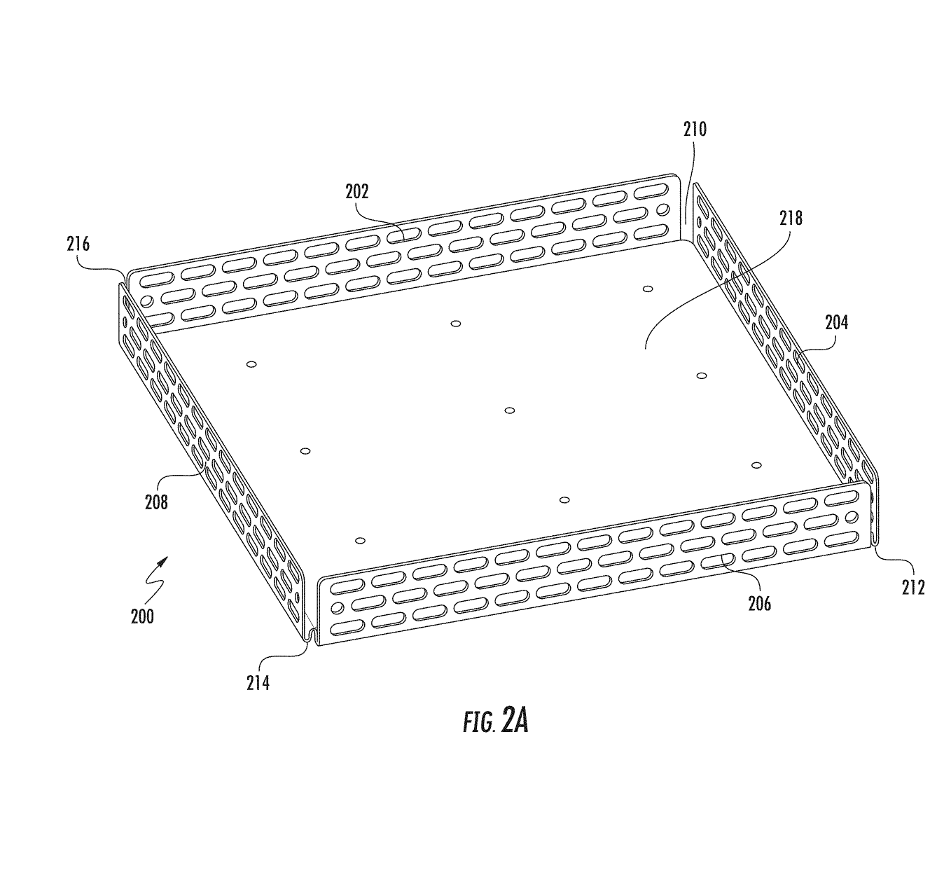

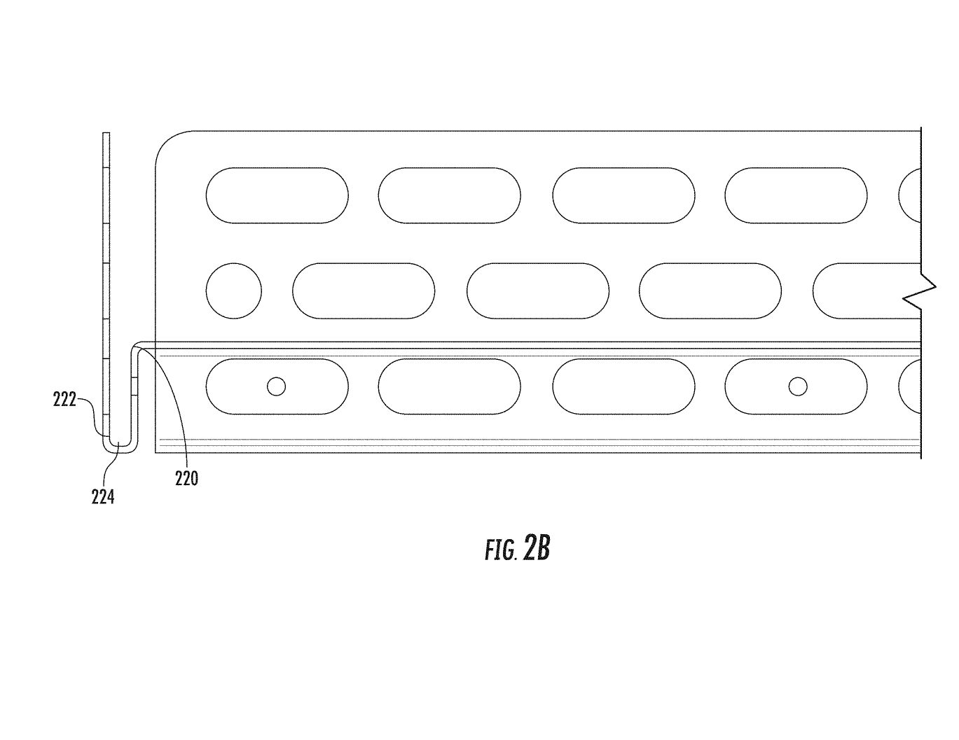

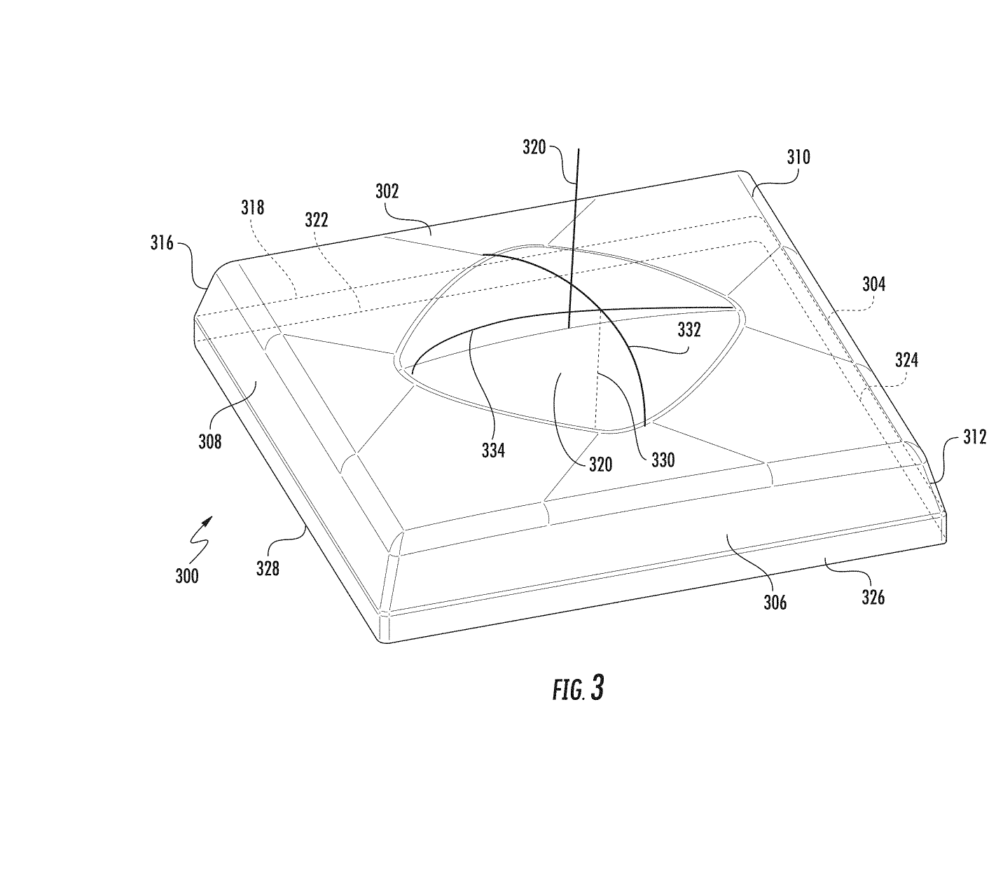

Referring to FIGS. 1A-1C, 2A, 2B, and 3, different views of a low band panel antenna 100 are illustrated. The low band panel antenna comprises a double bend reflector 200 (FIG. 2A) and a five-sided radome cover 300 (FIG. 3).

In certain embodiments, the double bend reflector 200 is formed from a metal plate by bending all side walls 202, 204, 206, 208 first downwardly along a first crease 220 (FIG. 2B) located at the edge of interior portion 218, and then upwardly along a second crease 222 (FIG. 2B) offset from the first crease, the result being vertical side walls disposed at a substantially right angle with the plane of interior portion 218, but with a u shape bend portion 224 (FIG. 2B) at the bottom of the side walls. This double bend feature not only increases the stiffness of all the side walls, which helps the panel antenna 100 to withstand strong wind, but also serves as a radio frequency (RF) choke, which prevents high frequencies from passing while let low frequencies pass, and improves front to back (F/B) ratio by trapping part of a radio frequency field. Between side walls 202, 204, 206 and 208 are vertical spaces 210, 212, 214, 216. Together, the four side walls define an interior portion 218. In certain embodiments, the interior portion 218 is substantially square. In certain embodiments, the width and length of the interior portion 218 have a range of about 600 mm to 750 mm, with a preferred embodiment of 700 mm. Further, the four side walls have a height of about 30 mm to 90 mm, with a height of 60 mm preferred. Apertures are optionally included in the reflector 200 as a weight saving measure. Apertures are sized and spaced to be electromagnetically invisible when the antenna is used in its preferred wavelength range of 698-940 MHz. It will appreciated that the geometry of the reflector allows it to be fabricated from a single sheet of material with only cutting and bending operations.

Moreover, in accordance with preferred embodiments of the present invention, the metal used to form the double bend reflector 200 is aluminum. However, it is known to a person of ordinary skill in radio antenna and wireless communication fields, other suitable types of metals can be used to form the double bend reflector. The aluminum metal plate has a thickness of about 2 mm to about 3.5 mm, with a preferred embodiment of 3 mm.

Referring now to FIG. 3, a five-sided radome cover 300 is illustrated. The fiver-sided cover 300 comprises a substantially square top portion 318. There are four trapezoidal shaped cover sides extend downwardly and outwardly from the top portion 318. Each of four substantially rectangular distal portions extends downwardly from each of the four trapezoidal cover sides. For example, the distal portion 322 extends downwardly from the cover side 302; the distal portion 324 extends downwardly from the cover side 304; the distal portion 326 extends downwardly from the cover side 306; and the distal portion 328 extends downwardly from the cover side 308. Further, all four substantially rectangular distal portions are parallel to a vertical y-axis 320. In addition, the distal portion 322 is substantially orthogonal to the distal portion 324; the distal portion 324 is substantially orthogonal to the distal portion 326; the distal portion 326 is substantially orthogonal to the distal portion 328; and the distal portion 328 is substantially orthogonal to the distal portion 322. Together, the cover side 302 and the distal portion 322 define a corner 310 with the cover side 304 and the distal portion 324; the cover side 304 and the distal portion 324 define a corner 312 with the cover side 306 and the distal portion 326; the cover side 306 and the distal portion 326 define a corner 314 with the cover side 308 and the distal portion 328; and the cover side 308 and the distal portion 328 define a corner 316 with the cover side 302 and the distal portion 322. Moreover, the top portion 318 and the four cover sides along with the four distal portions define an open bottom portion.

When the five-side cover 300 is disposed within the interior portion 218 of the reflector 200 to form the panel antenna 100 (FIGS. 1A-1C), each of the four cover sides along with each of the corresponding distal portions are disposed within each of the side walls of the reflector such that the corner 310 is disposed within the vertical space 210, the corner 312 is disposed within the vertical space 212, the corner 314 is disposed within the vertical space 214, and the corner 316 is disposed within the vertical space 216. The feature of exposed four side walls of the reflector 200 helps to maximize the panel antenna's directivity because a full metal surface of the interior portion and four side walls is utilized.

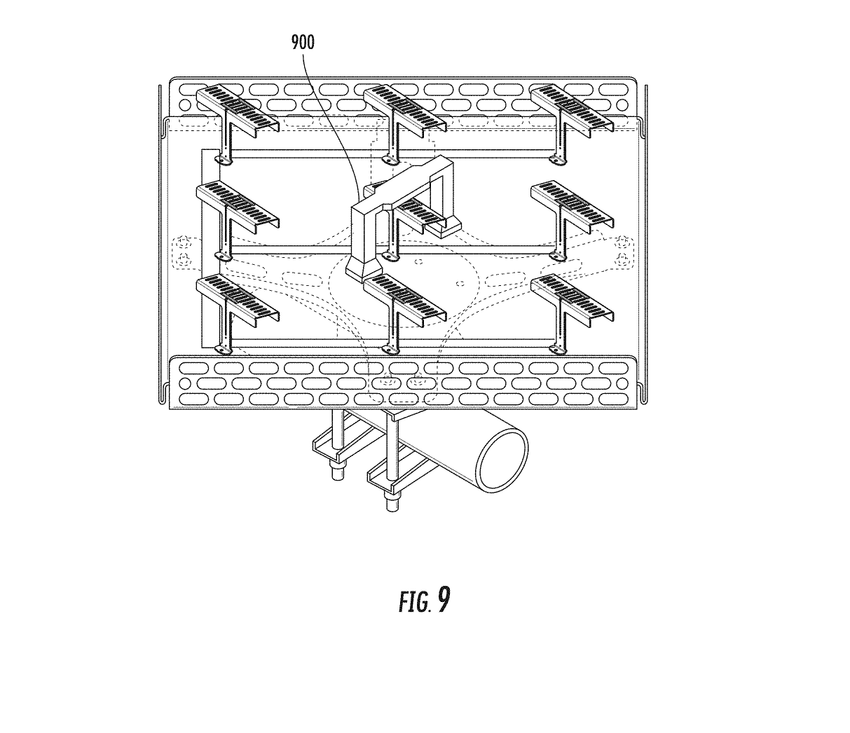

In certain embodiments, the top portion 318 comprises a dome 320, which is disposed substantially in the middle of the top portion 318. The dome 320 is located at a distance of about 150 mm to 200 mm away from each of four edges of the top portion 318, with a preferred distance of about 170 mm. The dome 320 comprises a radius of curvature 332 about an axis 330 and a transverse curvature 334 about the axis 330, which is parallel to the vertical y-axis 320. The dome 320 with the radius of curvatures 332 and 334 helps to improve the panel antenna 100's ability to withstand a high wind load with a survival wind speed of about 273 km/h when mounted to a structure outdoor, which is substantially higher than a panel antenna with a flat cover. In certain embodiments, each of the side walls of the reflector 200 (FIG. 2A) comprises a plurality of apertures extending through each of the side walls. This design feature also contributes to improved survival wind speed. Furthermore, having the dome 320 helps to reduce ripples in the top portion 318 of the five-side cover when it is installed within the reflector 200. Additionally, in certain embodiments, a u-shaped supporting bracket 900 (FIG. 9) is disposed in the middle of the interior portion 218 and right underneath the dome 320 to lend further support to said dome. In certain embodiments, supporting bracket 900 is made of plastic. By supporting the radome with supporting bracket 900, Applicants' antenna can survive hurricane force wind loads of 170 mph.

Additionally, in accordance with preferred embodiments of the present invention, the materials used to manufacture the five-sided cover 300 can be hand laid fiber glass. In other embodiments, the materials used to manufacture the five-sided cover can be thermo formed plastics. However, as is known to a person of ordinary skill in radio antenna and wireless communication fields, other types of electrically insulative materials are suitable to protect an array of dipole elements and are able to withstand a certain wind load can be used to form the five-sided cover 300.

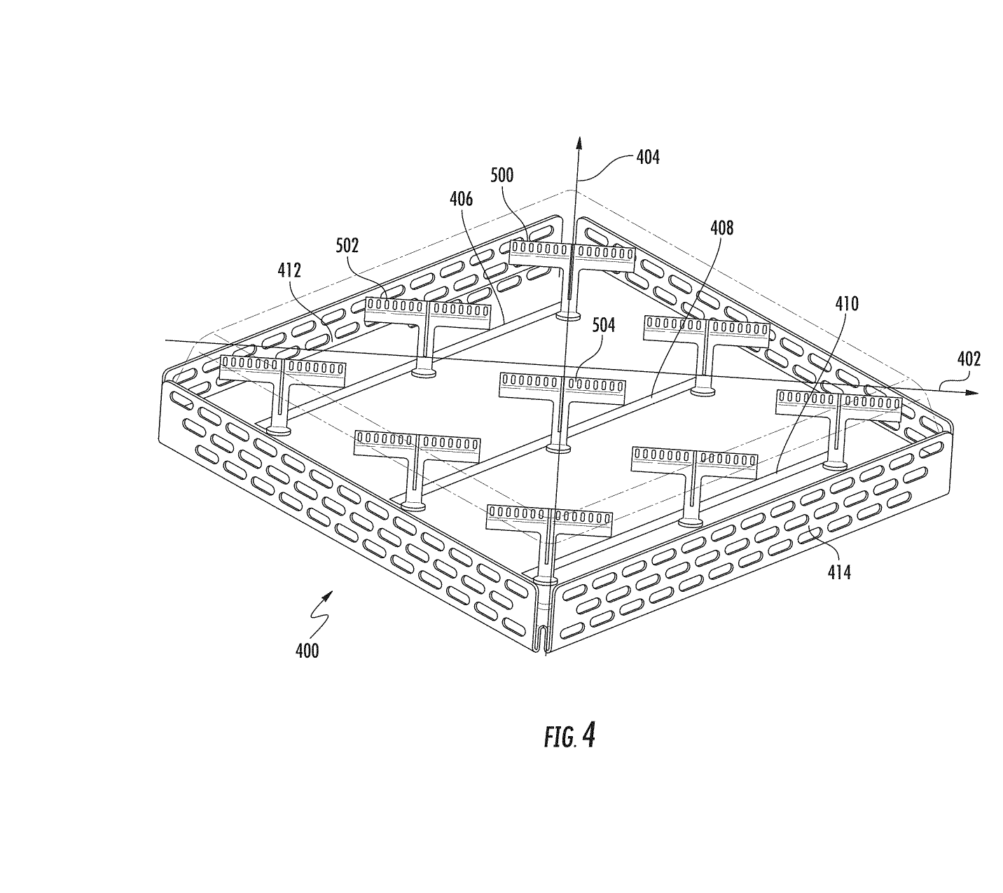

Referring to FIG. 4, an N×M array 400 of dipole elements is illustrated. In certain embodiments, the panel antenna comprises a 3×3 array of dipole elements, in other embodiments, the panel antenna comprises a 3×4 array of dipole elements. In yet other embodiments, the panel antenna comprises a 4×4 array of dipole elements. While specific values chosen for these embodiments are recited, it is to be understood that, within the scope of the invention, other suitable combinations of arrays of dipole elements can be used to suit different applications. However, it has been Observed that significant performance advantages are realized by using a 3×3 array of dipole elements over a 4×4 array, so long as the edge dipoles are located far enough away from the reflector edges to prevent fringing effects. It has been found that for dipole elements arranged at 45 degrees with respect to the reflector sidewalls, and having a length of 152 mm (corresponding to a half-wave dipole at about 820 MHz), good performance is achieved where the center of each dipole is greater than about 90 mm from the closest reflector edge.

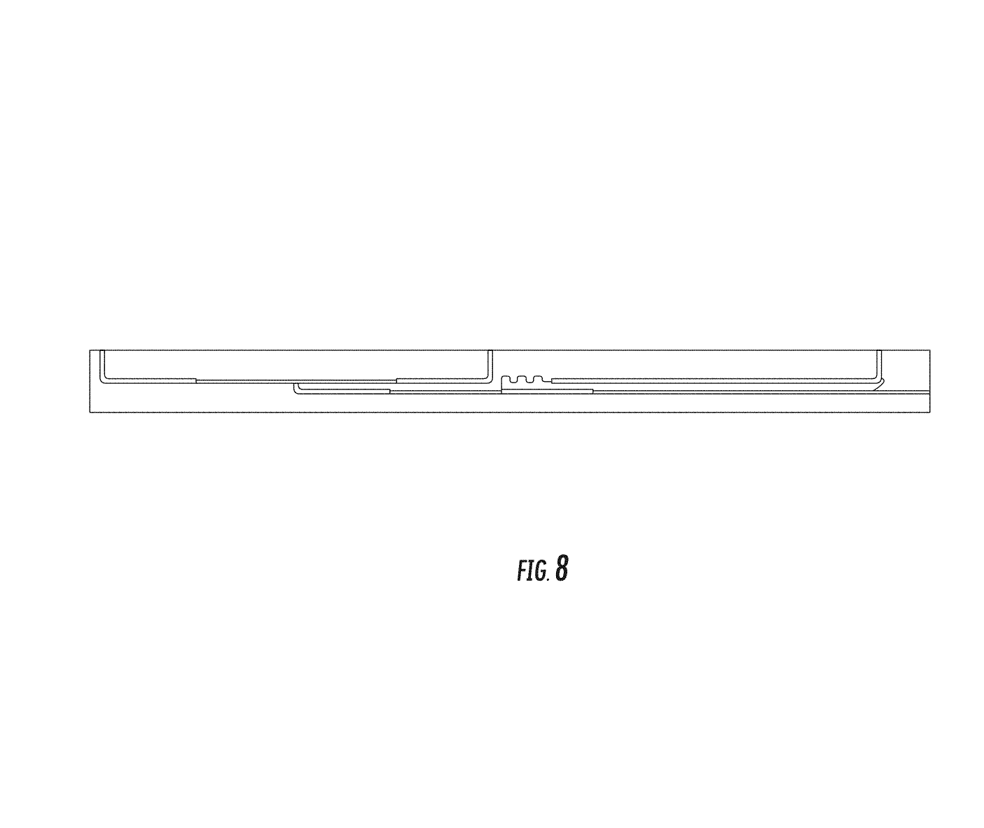

Further, FIG. 4 illustrates a plurality of integrated electrical feed lines, 406, 408, and 410 arranged as a three-way divider and FIG. 8 illustrates a side view of a feed line. In certain embodiments, the feed lines are made of copper, preferably clad in insulation in the form of a PCB. However, it is known to a person of ordinary skill in radio antenna and wireless communication field, other suitable types of conductive materials can be used to make the dividers. Each of the three feed lines is disposed on the interior portion 218 of the reflector 200 parallel to edges 412 and 414 of the interior portion 218. Each of the three feed lines includes insulative spacers to prevent electrical contact between the feed lines and the reflector. Additionally, each feed line includes printed circuit boards (PCBs) disposed in a way such that a single dipole element can directly connect to the PCB, via, for example, a PCB bridge or direct solder connection, without cables or cable connectors. Feed lines 406, 408, 410 are all connected to a bus feed line with runs parallel and proximate to one of the reflected side walls. In FIG. 4, the bus line is hidden from view by the lower left reflector wall, just above the reference numeral 400. The bus line is apparent on the left side of the top view of the array in FIG. 9.

Further, in a preferred embodiment, each of the dipole elements is coupled to a feed line in a way such that each dipole element is parallel to a diagonal line 402 of the interior portion 218 and is at a right angel to a diagonal line 404 of the interior portion 218. In a preferred embodiment, the distance in parallel between a dipole element 500 and a dipole element 502 is about 220 mm. Moreover, the distance in diagonal between the dipole element 500 and a dipole element 504 is about 240 mm. Similarly, with specific values chosen for this embodiment are recited, it is to be understood that, within the scope of the invention, the values of distances in parallel and/or in diagonal can vary over wide ranges to suit different applications.

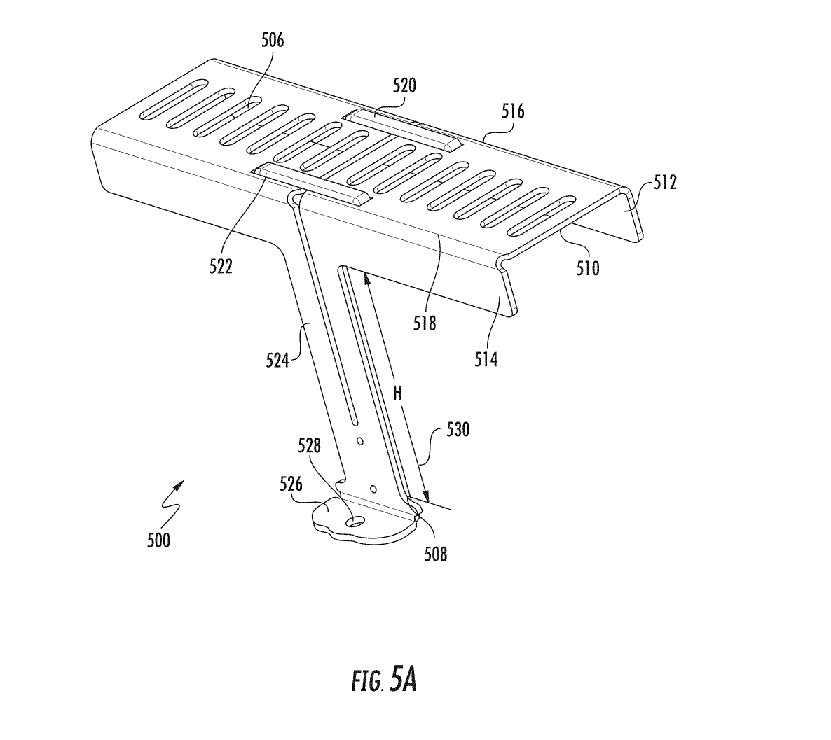

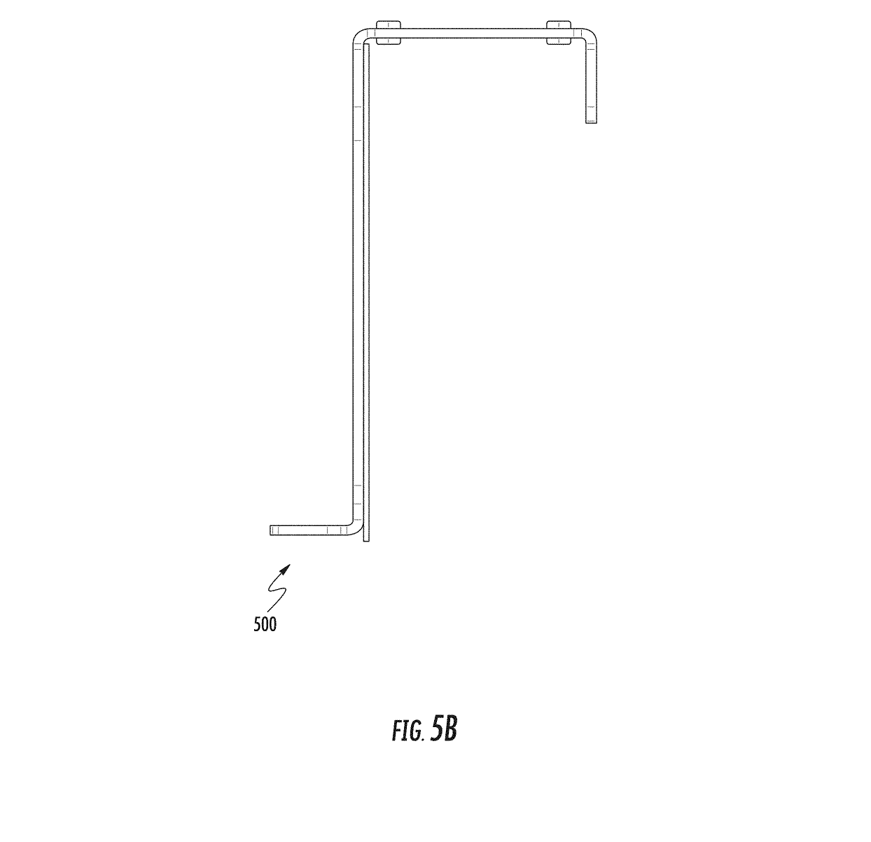

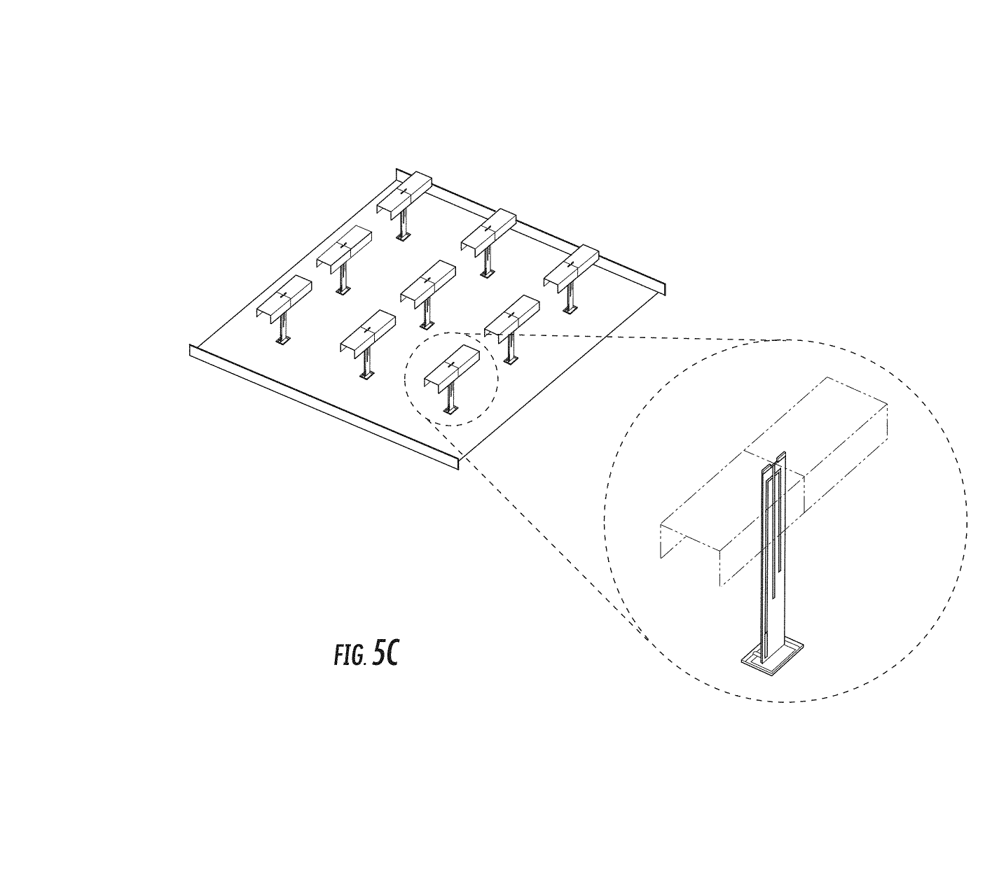

FIGS. 5A and 5B show different views of a single dipole element 500. The dipole element 500 is formed from a single piece metal sheet. In radio and telecommunications, a dipole antenna, a.k.a., a doublet, consists of two identical conductive elements such as metal wires or rods, which are usually bilaterally symmetrical, and fed or tapped at the junction between the elements. The length of the dipole element is typically one half wavelength of a designed-for center frequency. The driving current from a transmitter is applied or the output signal to the receiver of a receiving antenna is taken between the two halves of the dipole antenna. In certain embodiments, the metal used to form the dipole element 500 is aluminum. However, it is known to a person of ordinary skill in radio antenna and wireless communication fields, other suitable types of metals can be used to form the dipole element. Further, in certain embodiments, the aluminum sheet used to form dipole elements has a thickness of about 1 mm to about 2 mm, with a preferred thickness of about 1.5 mm.

In certain embodiments, the dipole element 500 comprises a top portion 506 and a bottom portion 508, which includes stem portion 524, which act as a support post. Bottom portion 508 also incorporates a j hook shaped conductor, electrically coupled to the feed line, which disposed in the stem portion 524 of the bottom portion 508. The j hook conductor is more clearly visible in FIG. 5C. The top portion 506 comprises a substantially rectangular middle portion 510, a substantially rectangular ledge 512, which is formed by bending the middle portion 510, flanks the middle portion 510 along a first length 516 at a substantially right angle, and a substantially rectangular ledge 514, which is formed by bending the middle portion 510, flanks the middle portion 510 along an opposite second length 518 at a substantially right angle. The bended areas along lengths 516 and 518 are designed to avoid cracks in the aluminum sheet that could potentially lead to deteriorated Passive Intermodulation (PIM). Moreover, the top portion 510 comprises a plurality of apertures extending therethrough. In some embodiments, the top portion 510 further comprises plastic inserts 520 and 522, which are used for gap control to improve RF repeatability.

In addition, in some embodiments, the bottom portion 508 comprises a stern 524 connecting to the ledge 514, which is orthogonal to the middle portion 510 and a foot 526, which comprises an aperture 528 extending therethrough for attaching to the divider or the PCB of the divider. In some embodiments, a wide foot 526 is used because the wider the foot, the better support for a dipole element is provided, especially under vibration. Further, the stem 524 has a height 530 of about 50 mm to about 85 mm, with a preferred embodiment of about 78 mm.

FIG. 5C illustrates an alternative dipole element. In the embodiment of FIG. 5C, bottom portion 508 is connected via stem portion 524 to the center, rather than the edge, of top portion 506. A J hook conductor is clearly visible in stem portion 524.

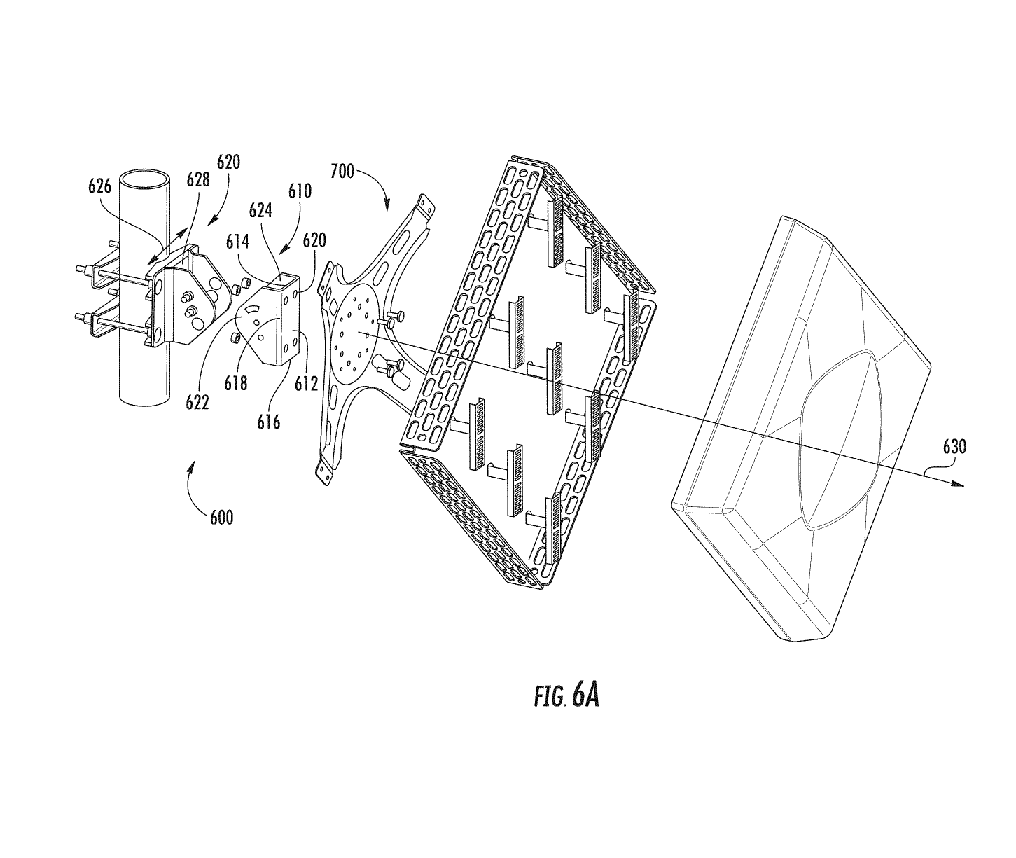

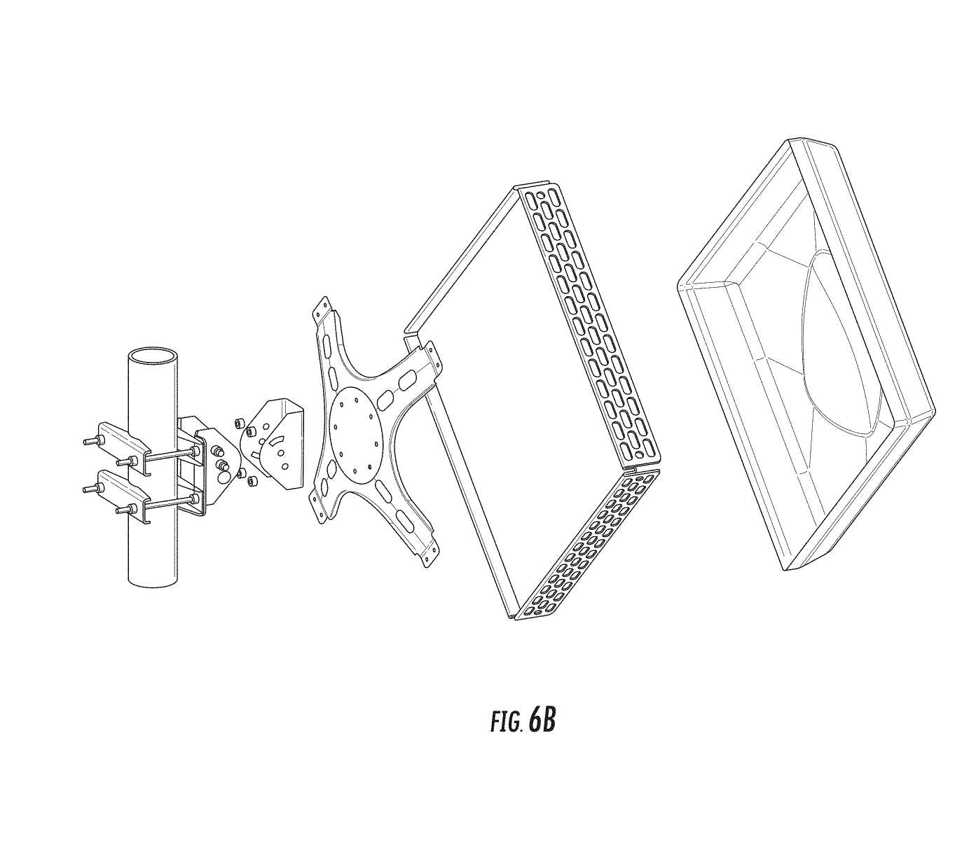

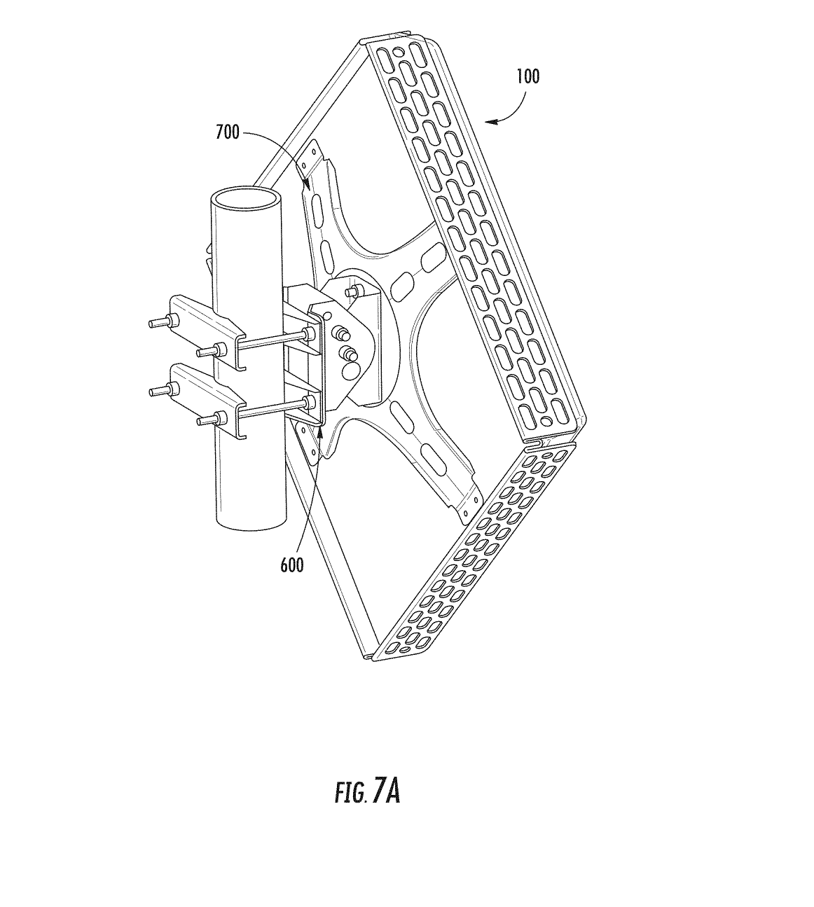

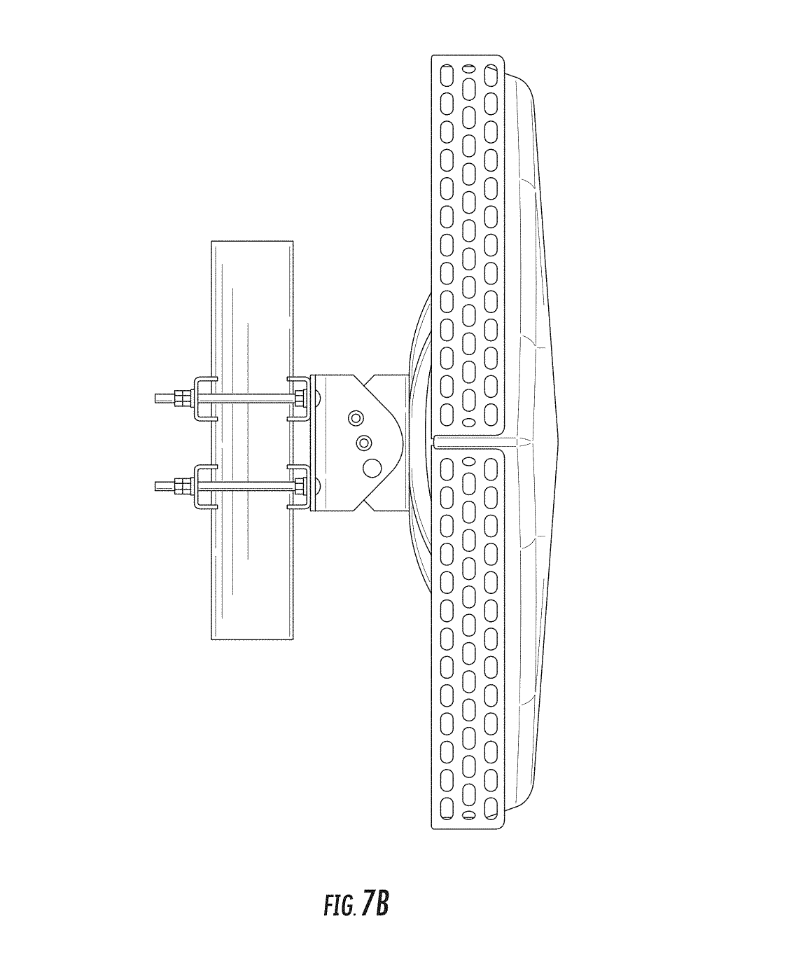

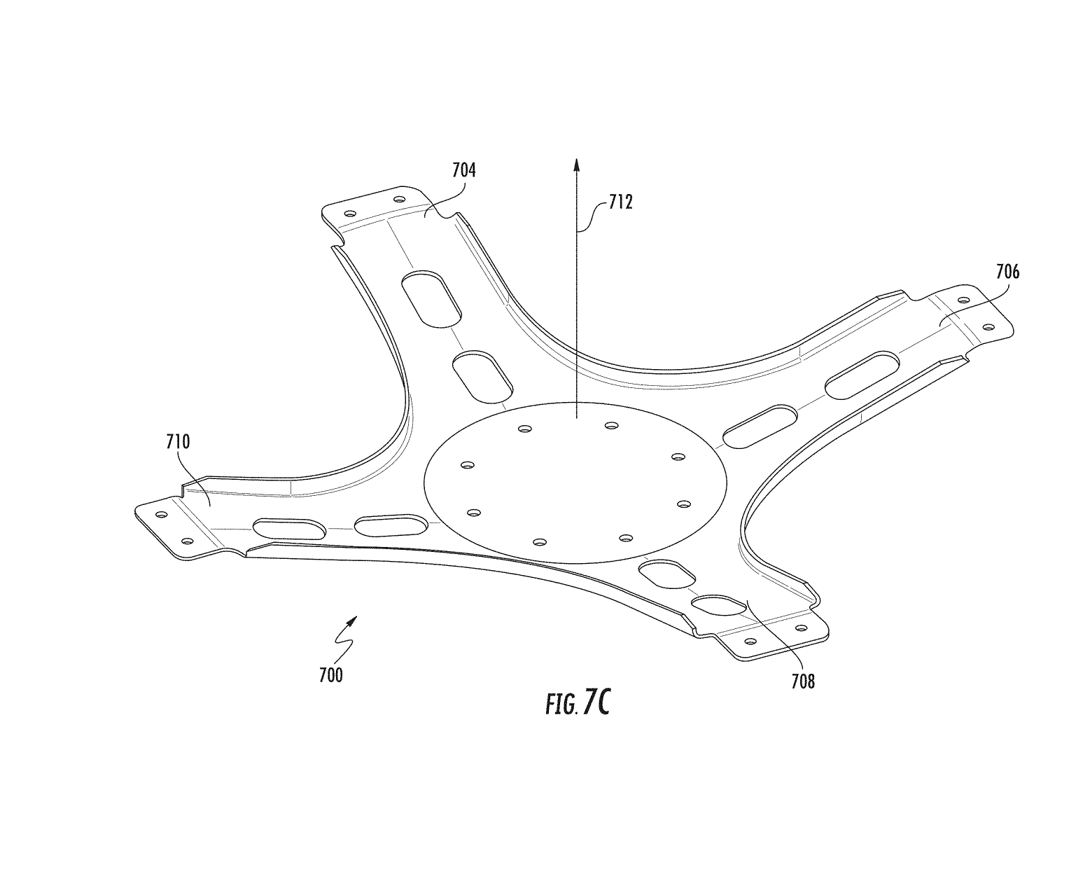

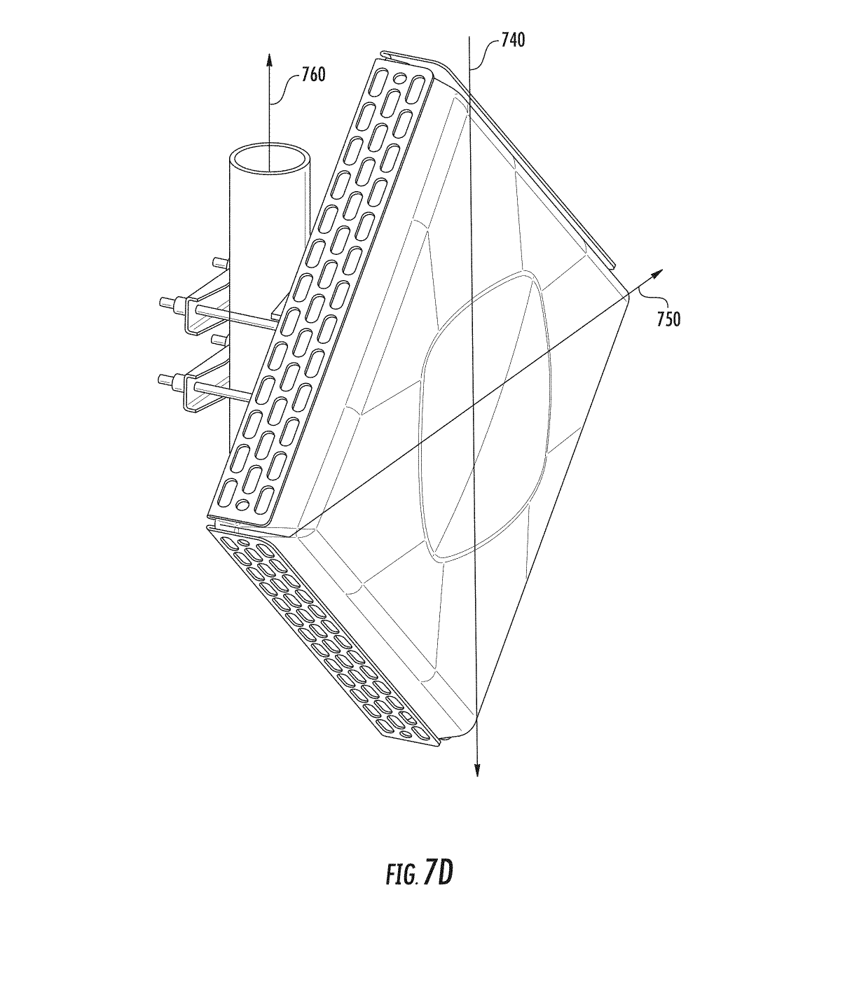

The other feature besides the features of the dome 320 of the five-sided cover 300 and the plurality of apertures in the side walls of the reflector 200 contributing to increased survival wind speed is Applicant's mounting assembly 600 as illustrated in FIGS. 6A and 6B. The mounting assembly 600 comprises a first bracket 610, a second bracket 620, and a concave brace 700 (FIG. 7).

In certain embodiments, the first bracket 610 comprises a substantially rectangular middle plate 612 with a first width 614, a second width 616, a first length 618, a second length 620, a first bracket side 622, and a second bracket side 624. Further, the first bracket side 622 is substantially orthogonal to the middle plate 612 and flanks the middle plate 612 along the length 618; and the second bracket side 624 is substantially orthogonal to the middle plate 612 and flanks the middle plate 612 along the length 620. The second bracket 620 has a similar structure as the first bracket 610 with one difference that a width 626 of a middle plate 628 is larger than the width of the middle plate 612 of the first bracket 610. As a result, the first bracket 610 can be disposed inside the second bracket 620 as illustrated in FIG. 7A. In certain embodiments, the first bracket 610 is mounted to the concave brace 700 via a first plurality of apertures extending through the middle plate 612. The second bracket 620 can be mounted to any structure for mounting the panel antenna 100 via a second plurality of apertures extending through the middle plate 628. It is known to a person of ordinary skill in the art that any suitable fasteners can be used to fasten the first bracket 610 to the concave brace 700 and/or fasten the second bracket 620 to any structure.

Further, in certain embodiments, the concave brace 700 (FIG. 7C) comprises a substantially circular middle plate 702 and a plurality of arms extending radially and outwardly therefrom. In some embodiments, the concave brace 700 comprises three arms. In other embodiments, the concave brace 700 comprises four arms. In yet other embodiments, the concave brace 700 comprises 6 arms. With specific values chosen for the number of the arms are recited, it is to be understood that, within the scope of the invention, the values of the number of the arms can vary over wide ranges to suit different applications. The circular middle plate 702 comprises a plurality of symmetrically arranged apertures for fasteners extending therethrough and evenly locating in a circle along the periphery of the circular middle plate 720. In a preferred embodiment, the circular middle plate 720 comprises 12 apertures extending therethrough. Once the concave brace 700 is mounted to the bottom of the reflector 200 via apertures extending through each distal end of the arms, the middle plate 702's apertures, which are disposed in a circular form, facilitate the rotation of the panel antenna along a horizontal x-axis 630 (FIG. 6A). In a preferred embodiment, concave brace 700, as well the additional mountain hardware of assembly 600, is made of steel, which allows for strong, rigid mounting of the antenna to an anchor such as a mast.

In another preferred embodiment, the concave brace 700 comprises four arms: a first arm 704, a second arm 706, a third arm 708, and a fourth arm 710. The arm 704 and the arm 708 have a first radius of curvature about a vertical z-axis 712. Similarly, the arm 706 and the arm 710 have a second radius of curvature about the z-axis 712. Further, the first and the second radii are substantially the same. The curvatures of the concave brace 700 reduces the bowing extension of the reflector 200 and the dome 320 after the entire panel antenna is mounted on a structure, especially under stress conditions.

Simulation Results

Applicant has tested different embodiments antennas described in the current disclosure. Table 1 below includes a non-exhaustive list of design parameters tested. During all the simulation tests, the panel antenna 100 is mounted to any structure in a way that a diagonal line 740 (FIG. 7B) of the five-sided cover 300 is parallel to a vertical z-axis 760 (FIG. 7B) and a transverse diagonal line 750 is also transverse to the vertical z-axis 760.

TABLE 1
Performance Comparison of Various RF Models

| | | 3 × 3 array | 3 × 3 array | 3 × 3 array | |
|---|---|---|---|---|---|
| | 3 × 3 array | 240 mm space | 240 mm space | 240 mm space | 4 × 4 array |
| | 220 mm space | 30 mm wall | 60 mm wall | 90 mm wall | 165 mm space |
| Directivity | 15.4-17.4 | 15.8-17.9 | 15.5-17.7 | 14.5-17.2 | 15.2-17 |
| (dBi) | | | | | |
| Front to Back | 34-40 | 23-29 | 35-40 | 25-38 | 30-38 |
| Ratio | (best average, all | | | | |
| (dB) | 40 except 1 freq.) | | | | |
| Azimuth | <−27 | <−27 | <−27 | <−24 | <−27 |
| SideLobes | | | | | |
| (dB) | | | | | |
| Azimuth and | 31.8-25.6 | 31-23.9 | 30.7-24.3 | 33.3-25.1 | 31.2-25 |
| Elevation 3 dB | 31.6-24.5 | 30-23.7 | 30.9-23.9 | 32.5-25.1 | |
| Beamwidth | | | | | |
| (degree) | | | | | |

Note:
All RF Models have antenna surface size of 700 mm × 700 mm

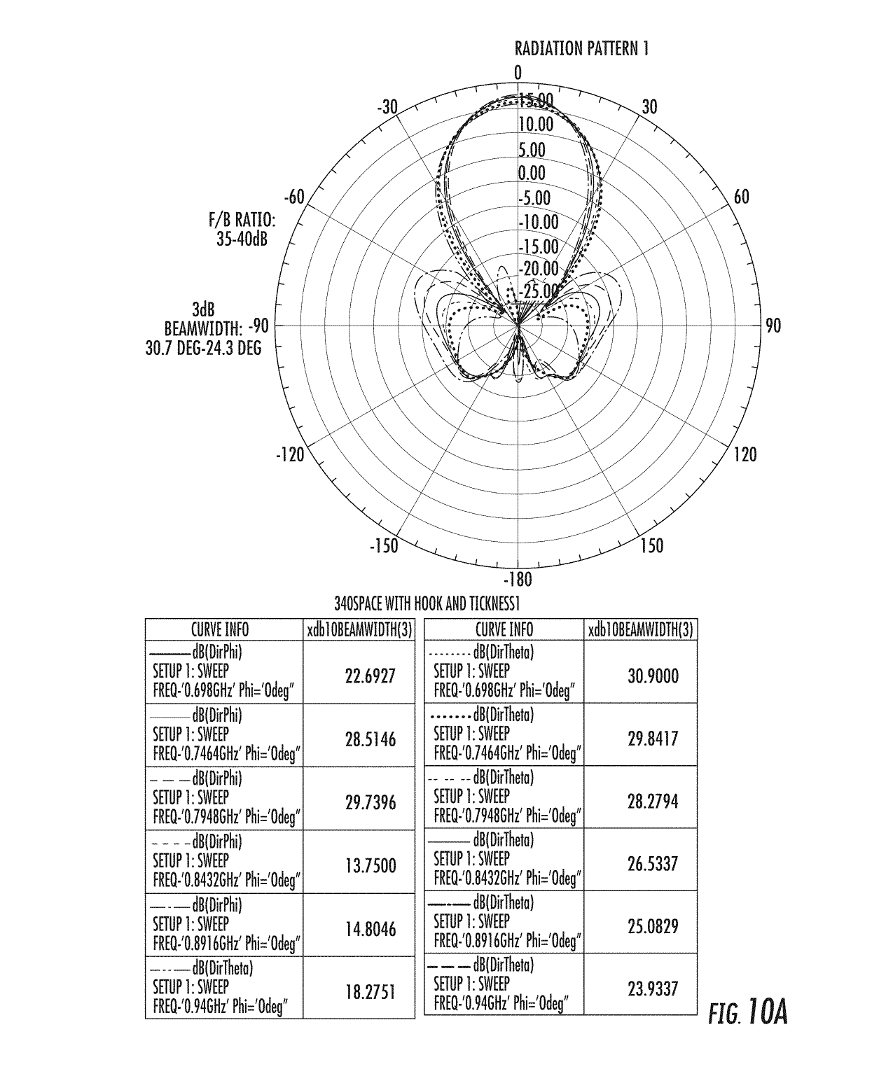

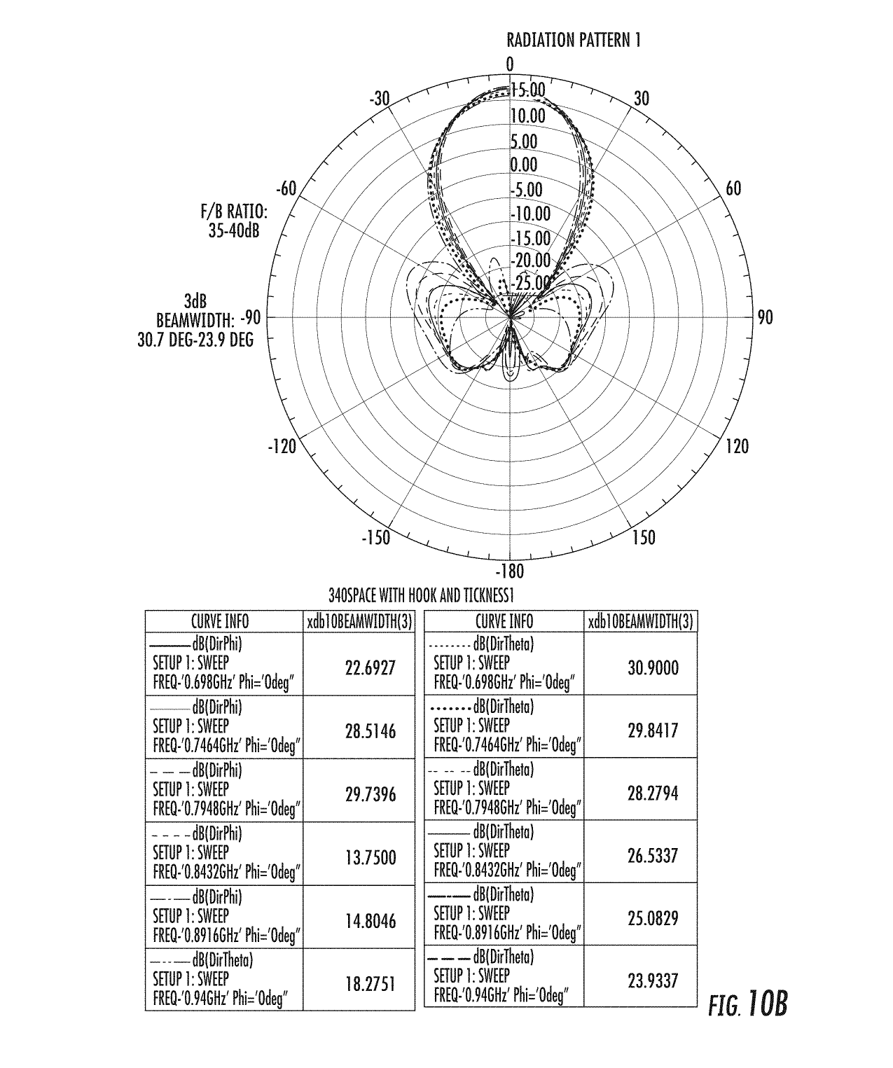

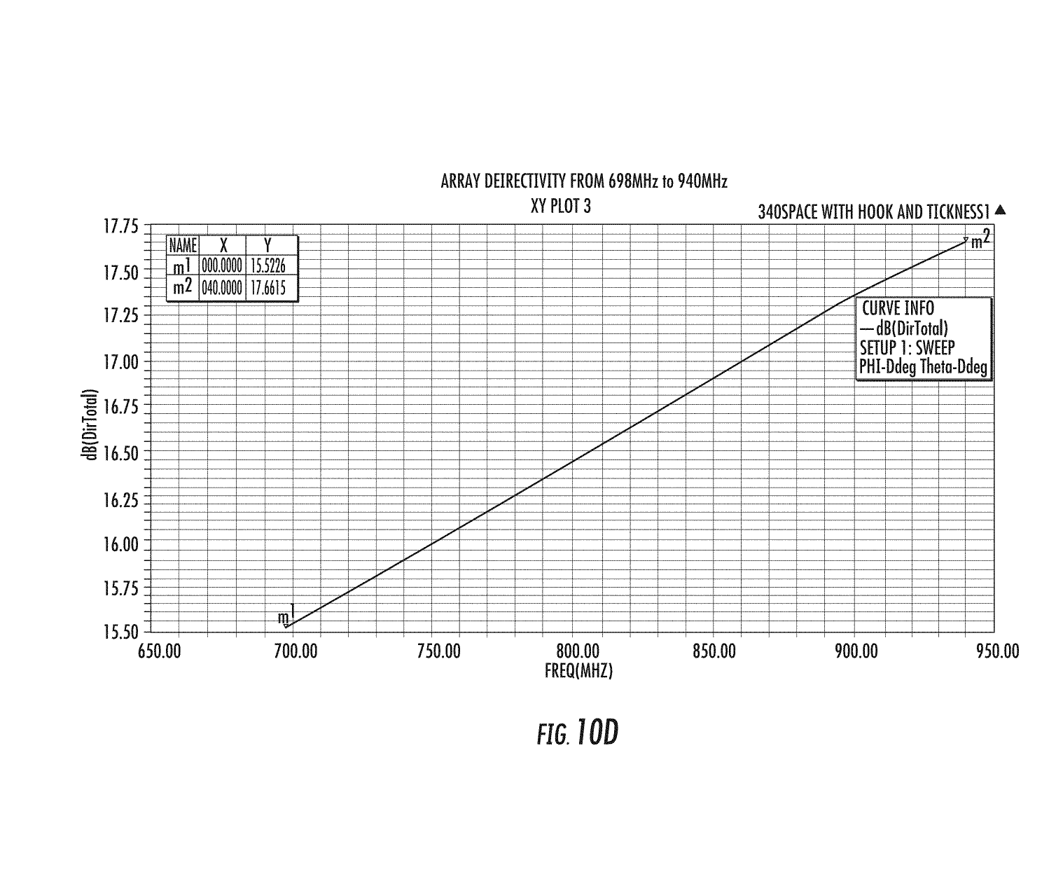

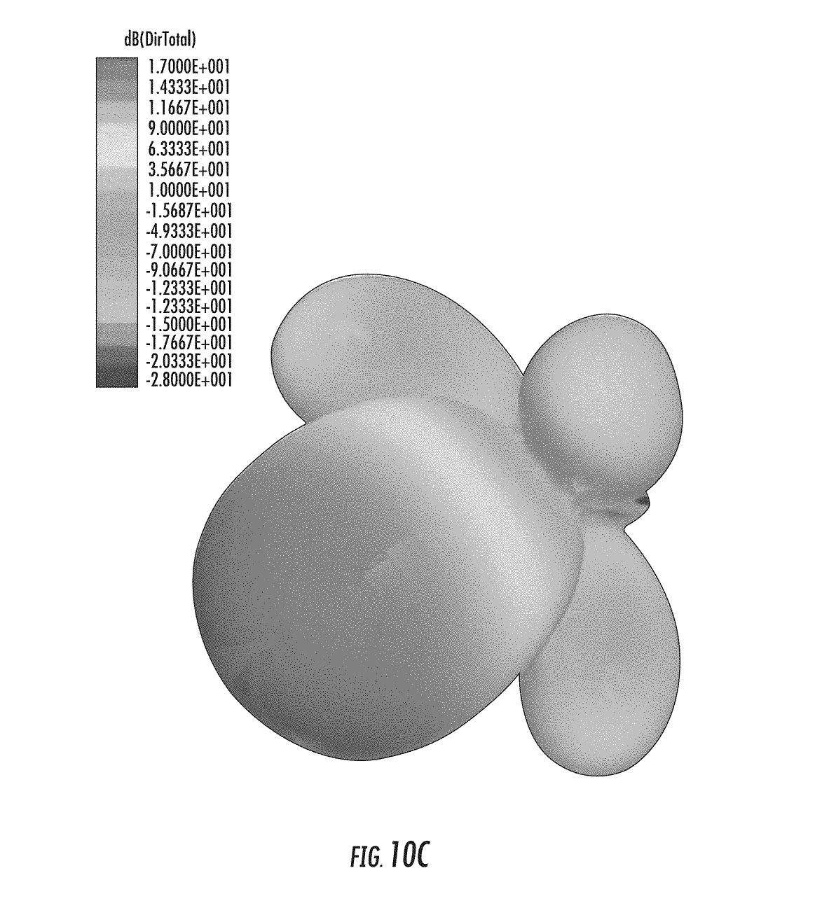

Referring to FIGS. 10A-10D, there are shown performance parameters, including azimuth gain scans over the preferred frequency band of interest, of a preferred configuration of the panel antenna 100 having a 3×3 array of dipole elements with 240 mm spacing in diagonal from an adjacent dipole element and 60 mm side walls of the reflector 200. Further FIGS. 10A-10D show directivity of the panel antenna 100 is from about 15.5 to about 17.7 dBi, which is about 0.5 dB on average higher than other panel antennas. Further, the F/B ratio of the panel antenna 100 is from about 35 to about 40 dB, which is about 5 dB on average better than other panel antennas.

Various physical antenna parameters may be changed an optimized to achieve various performance characteristics over various frequency ranges. It has been observed by applicants that, over the preferred frequency range of 698-940 MHz, it is helpful to vary the spacing of the dipole elements, and the height of the reflector walls, to achieve an optimum mix of F/B ratio, forward gain, and minimization of side lobe gain. In general terms, dipole elements must be sufficiently far away from the sidewall reflectors to avoid fringing effects and leakage, but they must not be closely packed so as to decrease the effective aperture of the reflector, which would decrease overall gain. The parameters reflected in the third column of Table 1 (240 mm element spacing, 152 mm length dipole, 3×3 array, 60 mm reflector sidewall height of a 700 mm×700 mm reflector) represent one advantageous embodiment, but other mixes of parameters are possible depending on design goals.

It will be appreciated by those skilled in the art that while the invention has been described above in connection with particular embodiments and examples, the invention is not necessarily so limited, and that numerous other embodiments, examples, uses, modifications and departures from the embodiments, examples and uses are intended to be encompassed by the claims attached hereto. Various features and advantages of the invention are set forth in the following claims.

What is claimed is:

1. A panel antenna assembly, comprising:
a double bend reflector having a plurality of side walls defining therebetween an interior portion;
a N×M array of dipole elements symmetrically disposed within said interior portion; and
a five-sided cover comprising a substantially square top portion and four cover sides attached to and extended downwardly and outwardly from said top portion to define an open bottom portion, wherein said top portion comprises a dome;
at least one rigid, integrated feed line attached to but electrically insulated from the interior portion of the reflector and in electrical contact with at least one of the dipole elements.

2. The assembly of claim 1, further comprising a mounting assembly that comprises a first bracket, a second bracket and a concave brace, wherein:
each of the two brackets comprises a substantially rectangular middle plate flanked by two bracket sides, wherein each of the two bracket sides is orthogonal to the rectangular plate;
each of the two brackets is configured to pivot in a single direction;
each of the two brackets is configured to mount the brace on a structure;
the concave brace comprises a substantially circular middle plate and a plurality of arms extending radially and outwardly from the circular plate; and
the concave brace is configured to attach to the reflector.

3. The assembly of claim 2, further comprising a pole-mounting assembly that comprises a first pole-mounting bracket, a second pole-mounting bracket, a third pole-mounting bracket, and a fourth pole-mounting bracket.

4. The assembly of claim 1, wherein each of the plurality of side walls comprises a plurality of apertures extending therethrough.

5. The assembly of claim 1, wherein the double bend reflector is further formed by bending each of the plurality of side walls in a first direction along a first crease at an edge of the interior portion followed by bending each of the plurality of side walls in an opposite second direction along a second crease offset from the first crease.

6. The assembly of claim 1, wherein N of the N×M array is 3 and M of the N×M is 3 or 4.

7. The assembly of claim 1, wherein each of the dipole elements comprises a metal sheet bent a plurality of times to form a top portion and a bottom portion, wherein:
the top portion comprises a substantially rectangular middle portion flanked by two ledges at each of two long sides thereof and a plurality of parallel apertures extending through the middle portion, wherein each of the two ledges is orthogonal to the rectangular middle portion; and
the bottom portion comprises a stem and a foot, wherein the stem extends downwardly from one of the two ledges and is disposed substantially in the middle of the ledge; the foot is configured to attach to a divider, and the stem includes a j hook conductor.

8. The assembly of claim 1, wherein each of the dipole elements is disposed within the interior portion of the reflector such that the top portion of each dipole element is parallel to one of two diagonals of the interior portion.

9. The assembly of claim 8, wherein a distance between the top portion of each of the dipole elements and the interior portion of the reflector has a range from 50 mm to 85 mm.

10. The assembly of claim 9, wherein the distance between the top portion of each of the dipole elements and the interior portion of the reflector is at least about 90 mm.

11. The assembly of claim 8, wherein each of the dipole elements is disposed at a distance of about 220 mm in parallel to an adjacent dipole element and at a distance of about 240 mm in diagonal to an adjacent dipole element.

12. The assembly of claim 1, wherein a supporting bracket is coupled to the reflector and is configured to support said dome.

13. The assembly of claim 1, wherein the at least one rigid feed line comprises a PCB and does not include cables or cable connectors.

14. An antenna assembly, comprising:
an array of dipole antenna elements having centers arranged in a square grid pattern;
a reflector including a rectangular planar portion and four side wall portions electrically connected to the planar portion and extending orthogonally to the planar portion;
a commonly connected feed network attached to the dipole antenna elements, the feed network including a plurality of PCB feed lines and a PCB bus line;
wherein, the dipole antenna elements have a length and a center spacing, and the reflector side walls have a height, and
wherein said length, center spacing and height are chosen as a function of one or more of: front-to-back ration, forward gain, and sidewall gain, for a predetermined frequency range.

15. The antenna assembly of claim 14, wherein the dipole antenna elements have a top portion having a long axis, and wherein said long axis makes a substantially non-zero angle with a long axis of each of the reflector side walls.

16. The antenna assembly of claim 15, wherein the substantially non-zero angle is about 45 degrees.

17. The antenna assembly of claim 14, further including a cover including a radome constructed of an electrically insulative material and sized to cover said dipole antenna elements and fit within a perimeter defined by the four side wall portions.

18. The antenna assembly of claim 17, further including a support bracket having at least two legs and a connecting portion connected therebetween, wherein the legs are attached to the planar surface of the reflector and the connecting portion is positioned to support the radome.

19. The antenna assembly of claim 1, wherein the dipole elements are arranged on a first side of the planar portion of the reflector, and further including a steel support bracket arranged on a second, opposite side of the planar portion and connected to the planar portion.

20. The antenna assembly of claim 1, wherein there are 9 dipole antenna elements arranged in a 3×3 grid.
